(19) United States
(12) Patent Application Publication
(10) Pub. No.: US 2026/0296844 A1
(43) Pub. Date: Oct. 1, 2026

(54) TRANSPORT ARRANGEMENT

(71) Applicant: Hans Künz GmbH, Hard (AT)

(72) Inventor: Georg KLAPPER, Hard (AT)

(73) Assignee: Hans Künz GmbH, Hard (AT)

(21) Appl. No.: 19/556,436

(22) Filed: Mar. 4, 2026

(30) Foreign Application Priority Data
Mar. 26, 2025 (AT) A47/2025

(51) Int. Cl. B66C 19/00

(52) U.S. Cl. CPC B66C 19/007

(57) ABSTRACT

A transport arrangement (1) for transporting a container (2) or another load. The transport arrangement has a trolley (3), a load suspension device (4) and eight lifting cables (5, 6). The trolley has cable drums (9), and at least one of the lifting cables is mounted on each of the cable drums for winding and unwinding. The transport arrangement has two mutually opposite end sides (10) and two mutually opposite longitudinal sides (11), and in each case two of the lifting cables (5) are arranged as end-side lifting cables on each of the end sides, each end-side lifting cable is guided from the respective cable drum on a first end-cable section (12) to a first end-side deflection pulley (13) and on a second end-cable section (14) to a second end-side deflection pulley (13) and on a third end-cable section (16) to a fixed end-side fastening point (17) on the trolley.

### CROSS-REFERENCE TO RELATED APPLICATIONS

This application claims priority from Austrian Patent Application No. A 47/2025, filed Mar. 26, 2025, which is incorporated herein by reference as if fully set forth.

### TECHNICAL FIELD

The present invention relates to a transport arrangement for transporting a container or another load, wherein the transport arrangement has a trolley and a load suspension device and eight lifting cables, wherein the load suspension device has at least one fastening unit for fastening the container or the other load to the load suspension device, and the load suspension device hangs height-adjustably on the trolley by means of the lifting cables, wherein the trolley has two or more cable drums, and at least one of the lifting cables is mounted on each of the cable drums so as to be able to be wound up and unwound, and wherein the transport arrangement, in particular the load suspension device, has two mutually opposite end sides and two mutually opposite longitudinal sides, the longitudinal sides being longer than the end sides.

### BACKGROUND

A transport arrangement of the type in question is known, for example, from WO 97/08094.

In this document, as also in other documents from the prior art, the ends of the lifting cables opposite the respective cable drum have to be fastened to the trolley by means of additional cable drums or else by means of length-changeable fastenings, in order to be able to compensate for the different change in length in the eight lifting cables when the load suspension device is being lifted and lowered relative to the trolley.

### SUMMARY

It is the object of the invention to provide a transport arrangement of the type mentioned at the beginning, in which these additional measures for compensating for various changes in length in the lifting cables can be dispensed with.

For this purpose, the invention provides a transport arrangement having one or more of the features disclosed herein.

It is thus provided according to the invention that in each case two of the lifting cables are arranged as end-side lifting cables on each of the end sides, each of said end-side lifting cables being guided from the respective cable drum on a first end-cable section to a first end-side deflection pulley, which is fastened to the load suspension device, and on a second end-cable section to a second end-side deflection pulley, which is fastened to the load suspension device, and on a third end-cable section to a fixed end-side fastening point on the trolley.

Surprisingly, it has been shown that these measures mentioned make it possible to dispense with the abovementioned additional cable drums or the length-changeable suspensions of the lifting cables. In the case of transport arrangements according to the invention, the changes in length in the various lifting cables during the winding up and unwinding are so small that, for their compensation, the elastic elongation possible in the lifting cables themselves is sufficient to compensate for these differences. In this connection, it should also be pointed out that the fixed end-side fastening points fasten the respective lifting cable fixedly to the trolley. The additional cable drums or length-changeable fastening points can be dispensed with in the invention.

The end-cable sections could also be referred to as end-cable portions. The first end-cable section is in each case that portion of the respective end-side lifting cable which is located between the respective cable drum and the first end-side deflection pulley. The second end-cable section is that portion of the respective lifting cable which is located between the first deflection pulley and the second deflection pulley of the respective lifting cable. The third end-cable section is respectively that portion of the respective lifting cable which is located between the second deflection pulley and the fixed end-side fastening point on the trolley. When the load suspension device is lowered and lifted in relation to the trolley, the change in length correspondingly always occurs in the first and third end-cable sections. For the sake of completeness, it is pointed out that, in the selected choice of words, each of the end-side lifting cables is assigned a, preferably individual, first deflection pulley and a, preferably individual, second deflection pulley.

Transport arrangements according to the invention have at least eight lifting cables. Particularly preferred embodiments of the transport arrangement according to the invention have precisely eight lifting cables.

The minimum number of cable drums of the transport arrangements according to the invention consists in the embodiments with precisely two cable drums. This can be realized particularly cost-effectively since only two cable drums with the corresponding drives have to be provided for rotating the cable drums about their respective cable drum axis. In these preferred embodiments with two cable drums, precisely four lifting cables, in particular precisely two end-side lifting cables and precisely two longitudinal lifting cables, can be wound up onto, and unwound from, one of the cable drums. However, transport arrangements according to the invention may also be realized with more than two cable drums. In particular, embodiments with four cable drums and with eight cable drums should be mentioned in this connection. In the case of four cable drums, two of the lifting cables are preferably wound up onto, and unwound from, each cable drum. In embodiments with eight cable drums, it is preferably provided that each lifting cable is assigned precisely one, i. e separate, cable drum. However, the embodiment with more than two cable drums is correspondingly more expensive to realize, since more drives are also required for rotating the cable drums about their respective cable drum axis. However, they have the advantage that the individually activatable cable drums with their drives can be used for fine positioning of the load suspension device and thus also of the container fastened thereto or of the other load fastened thereto. Another variant in which this fine positioning can be realized in transport arrangements according to the invention consists in fastening the respective first and second end-side deflection pulleys to the load suspension device so as to be adjustable in their distance relative to each other.

In particularly preferred embodiments, it is provided that the end-side lifting cables each run substantially vertically on their first end-cable section by enclosing an angle of a maximum of 4° with the vertical. Another preferred embodiment consists in that the end-side lifting cables each run substantially horizontally on their second end-cable section by enclosing an angle of a maximum of 4° with the horizontal. Owing to this substantially vertical course of the first end-cable section and/or the substantially horizontal course of the second end-cable section, the different changes in length in the lifting cables as the load suspension device is being lifted and lowered relative to the trolley can be particularly readily minimized. Another preferred measure in this context is that, in the case of the end-side lifting cables, as seen in a side view of the respective end side, the third end-cable section of the respective end-side lifting cable runs at an acute angle relative to the second end-cable section of the respective end-side lifting cable.

It is also advantageous in this context if it is provided that, in the case of the end-side lifting cables, as seen in a side view of the respective end side, in each case the third end-cable section of the respective end-side lifting cable crosses the first end-cable section of the respective end-side lifting cable. Preferably, it is provided that, in the case of the end-side lifting cables, as seen in a side view of the respective end side, the second end-side deflection pulley of the respective end-side lifting cable and the fixed end-side fastening point of the respective end-side lifting cable are arranged on mutually opposite sides of the first end-cable section of the respective end-side lifting cable.

In preferred embodiments, as a further measure for compensating for different changes in length in the various lifting cables, it is provided that the fixed end-side fastening points of the end-side lifting cables are each preceded by a deflection link with a curved deflection surface, wherein the respective end-side lifting cable is guided in each case with its third end-cable section over the curved deflection surface. By means of the curved deflection surfaces of the deflection links, additionally improved compensation of the different changes in length in the lifting cables can be made when winding the lifting cables up onto, and unwinding same from, the cable drums. These deflection links can therefore be used as a fine optimization in order to only have to compensate for particularly small differences in length because of the elastic elongation of the lifting cables. In particular, in this context, geometric deviations in the change in length between the end-side and the longitudinal lifting cables can be further reduced in order to keep the different elastic cable elongation and the associated redistribution of force as low as possible.

In preferred embodiments of the invention, the first end-side deflection pulley and the second end-side deflection pulley of the respective end-side lifting cable are arranged as close as possible to the edge of the load suspension device. In this context, it is therefore advantageously provided that, as seen in a side view of the respective end side, the first end-side deflection pulley and the second end-side deflection pulley of each end-side lifting cable are each arranged on the load suspension device closer to an edge of the load suspension device than to a centre of the load suspension device.

Overall, a symmetrical arrangement of the lifting cables is advantageous. Preferably, it is thus provided that, as seen in a side view of the respective end side, the two end-side lifting cables arranged on the respective end sides are arranged mirror-symmetrically to each other.

It has been shown that, for each end-side lifting cable, the first end-cable section and the second end-cable section and also the third end-cable section should run as close to each other as possible in one plane. This is not completely possible in practice, especially in embodiments in which the third end-cable section crosses the first end-cable section. However, it is preferably provided that, as seen in a top view of the load suspension device, the first end-cable section and the second end-cable section and the third end-cable section of the respective end-side lifting cable run completely between two imaginary, vertical planes which are parallel to each other, the planes being at a distance from each other in a range of 150 mm to 250 mm, preferably in a range of 180 mm to 220 mm.

With regard to the arrangement of the cable drums of the trolley, preferred embodiment variants of the invention make provision that the cable drums are each rotatably mounted about a cable drum axis and the cable drum axes of the cable drums are arranged parallel to each other and/or running parallel to the end sides. This applies both to embodiments with two cable drums and to embodiments with more than two, in particular with four or eight, cable drums.

In addition to the aforementioned preferred embodiments, which relate to the end-side lifting cables, there are also preferred variants of the invention with regard to the course of the longitudinal lifting cables. In this context, it is particularly preferably provided that two of the lifting cables are arranged as longitudinal lifting cables on each of the longitudinal sides, each of said longitudinal lifting cables being guided from the respective cable drum on a first longitudinal-cable section to a longitudinal deflection pulley, fastened to the load suspension device, and on a second longitudinal-cable section to a fixed longitudinal fastening point on the trolley. The first longitudinal-cable section and the second longitudinal-cable section preferably run substantially parallel to each other. Here, too, “substantially” means that a deviation of a maximum of 4° from the exact parallelism is still included. In a further preferred embodiment, it is provided that the longitudinal deflection pulleys, as seen in a side view of the respective longitudinal side, are each fastened to the load suspension device in a centre of the load suspension device. A symmetrical arrangement is also preferred for the longitudinal lifting cables. In this context, it can therefore be provided that, as seen in a side view of the respective longitudinal side, the two longitudinal lifting cables arranged on the respective longitudinal sides are arranged mirror-symmetrically to each other.

In addition to the transport arrangement per se, the invention also relates to a crane with at least one longitudinal member on which a transport arrangement according to the invention is mounted movably by means of its trolley along the longitudinal member. Such cranes according to the invention may be designed in particular as gantry cranes or overhead cranes. They may have only one or else a plurality of longitudinal members on which the trolley is mounted movably in a manner known per se.

As already explained at the beginning, not only containers but also other loads can be fastened to the load suspension device of transport arrangements according to the invention. The load suspension devices and the fastening unit(s) thereof may be designed differently depending on the type of load. Suitable load suspension devices and also fastening units for the transport of containers are known per se in the same way as those for loads such as logs, scrap, bulk material, etc., and therefore this does not have to be further explained here.

### BRIEF DESCRIPTION OF THE DRAWINGS

Further features and details of preferred embodiments of the invention are explained below with reference to the attached figures. In the figures:

FIG. 1 shows a crane according to the invention in the form of a gantry crane having a transport arrangement according to the invention;

FIG. 2 shows a crane according to the invention in the form of an overhead crane having a transport arrangement according to the invention;

FIG. 3 shows a perspective illustration of the transport arrangement of FIGS. 1 and 2, illustrated without a trolley;

FIGS. 4 and 5 show views of the end side of the transport arrangement from FIGS. 1 and 2;

FIGS. 6 to 9 show views of the end side of the transport arrangement from FIGS. 1 and 2, with in each case only one end-side lifting cable being illustrated;

FIG. 10 shows a view of the longitudinal side of the transport arrangement from FIGS. 1 and 2;

FIG. 11 shows a view downwards from the intersecting plane A-A from FIG. 10, and

FIG. 12 shows a further view of the longitudinal side of the transport arrangement from FIGS. 1 and 2.

### DETAILED DESCRIPTION

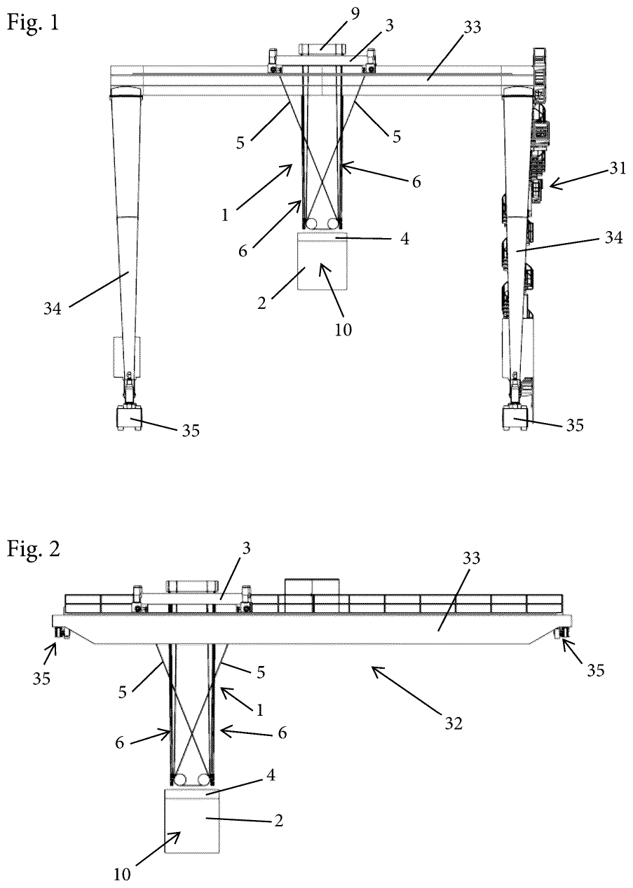

FIG. 1 shows, somewhat schematically, a crane according to the invention in the form of a gantry crane 31. The latter has a longitudinal member 33, which sits on supports 34. The supports 34 have running gears 35, with which the crane, depending on the configuration of the running gears 35, can be moved on a corresponding substrate or on rails. This is known per se and does not have to be explained further. Such cranes may have one or more longitudinal members 33 on which the transport arrangement 1 is mounted movably to and fro by means of its trolley 3. In the case of the gantry crane 31 of FIG. 1, the transport arrangement 1 is designed according to the invention as is the transport arrangement 1 of the overhead crane 32 from FIG. 2. The overhead crane 32 according to the invention differs from the gantry crane 31, as known per se, essentially in that there are no supports 34 and instead the longitudinal member 33 directly has running gears 35, with which it can be moved, for example, on a hangar ceiling or on supports, walls, optionally on rails arranged there. Also here, in the exemplary embodiment according to FIG. 2, the transport arrangement 1 can be moved by means of its trolley 3 along the at least one longitudinal member 33 of the overhead crane 32.

The transport arrangement 1 according to the invention is designed identically in the case of the two cranes from FIGS. 1 and 2 and will be explained in more detail below. It involves a transport arrangement 1 for transporting a container 2, having a trolley 3 and a load suspension device 4 and having precisely eight lifting cables 5 and 6. The load suspension device 4 has one or more fastening units 7 for fastening the container 2 to the load suspension device 4. The fastening units 7 are known per se and do not have to be explained further or illustrated in more detail here. The load suspension device 4 hangs height-adjustably on the trolley 3 at least by means of the lifting cables 5 and 6. In the exemplary embodiments shown here, the trolley 2 has precisely two cable drums 9 arranged at a distance from each other and, in the exemplary embodiments shown here, in each case two end-side lifting cables 5 and two longitudinal lifting cables 6 are mounted on each of the cable drums 9 so as to be able to be wound up and unwound. It has already been explained at the beginning that there may also be more than two cable drums 9. In particular, there may also be four or eight cable drums 9. In the case of four cable drums 9, two lifting cables 5 and 6 are mounted on each cable drum so as to be able to be wound up and unwound and, in the case of eight cable drums, in each case one lifting cable 5 or 6 is mounted on the respective cable drum 9 so as to be able to be wound up and unwound.

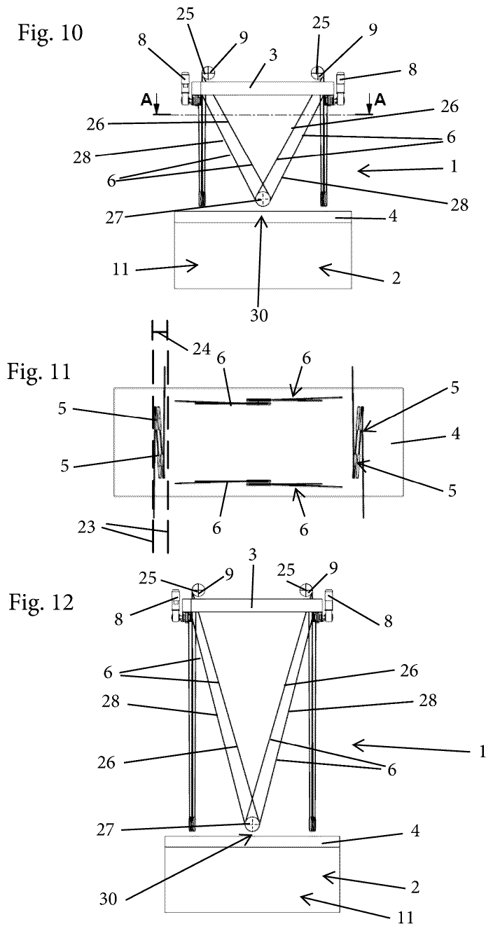

In the exemplary embodiments of the transport arrangement 1 shown here, the transport arrangement 1 and in particular the load suspension device 4 has two mutually opposite end sides 10 and two mutually opposite longitudinal sides 11, the longitudinal sides 11 being longer than the end sides 10. FIGS. 1 and 10 each show views of the end sides 10.

As explained in detail further below, it is provided in the invention that in each case two of the lifting cables 5 are arranged as end-side lifting cables 5 on each of the end sides 10, each of said end-side lifting cables 5 being guided from the respective cable drum 9 on a first end-cable section 12 to a first end-side deflection pulley 13, which is fastened to the load suspension device 4, and on a second end-cable section 14 to a second end-side deflection pulley 15, which is fastened to the load suspension device 4, and on a third end-cable section 16 to a fixed end-side fastening point 17 on the trolley 3. In contrast to the prior art mentioned at the beginning, the fixed end-side fastening points 17 are not adjustable in their length, and therefore the end-side lifting cables 5 are fastened fixedly to the trolley 3 at their ends opposite the respective cable drum 9.

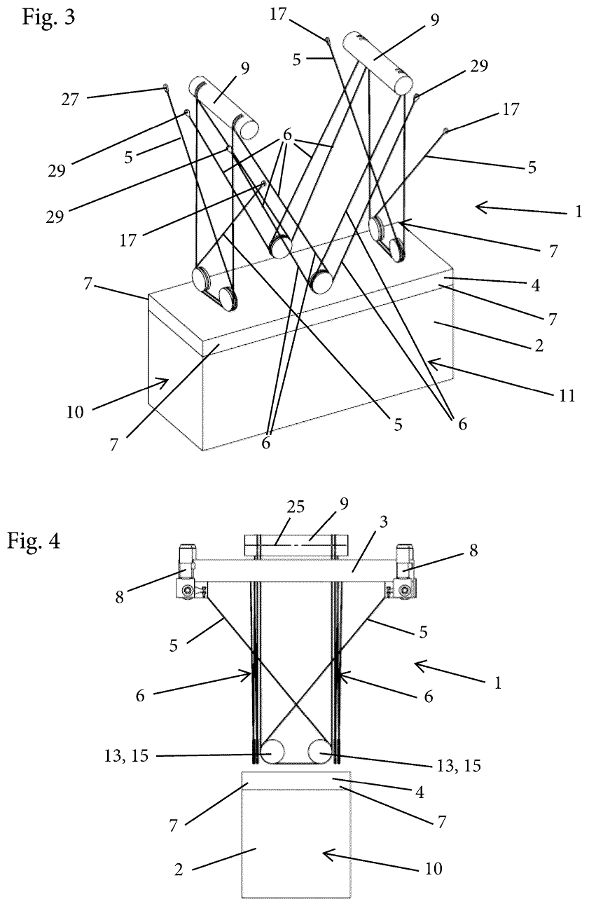

FIG. 3 shows a perspective illustration obliquely from above of the transport arrangement 1 from FIGS. 1 and 2; however, the trolley 3 is not illustrated in FIG. 3. It is readily seen in FIG. 3 that the longitudinal sides 11 are longer than the end sides 10. In addition, the course of the end-side lifting cables 5 and also of the longitudinal lifting cables 6 is visible, as is explained in more detail further below. Also visible are the fixed end-side fastening points 17 for the end-side lifting cables 5, which, as already explained, are fastened correspondingly fixedly, i.e. not length-adjustably, to the trolley 3. However, the fixed longitudinal fastening points 29, with which the longitudinal lifting cables 6 are fastened fixedly, i.e. likewise not length-adjustably, to the trolley 3, are also seen in FIG. 3.

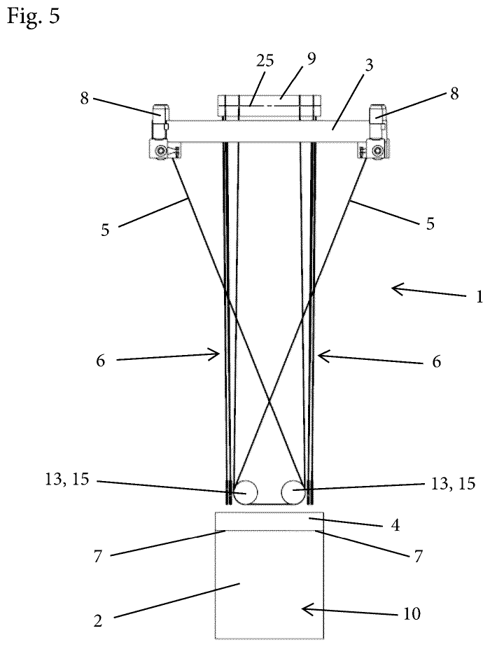

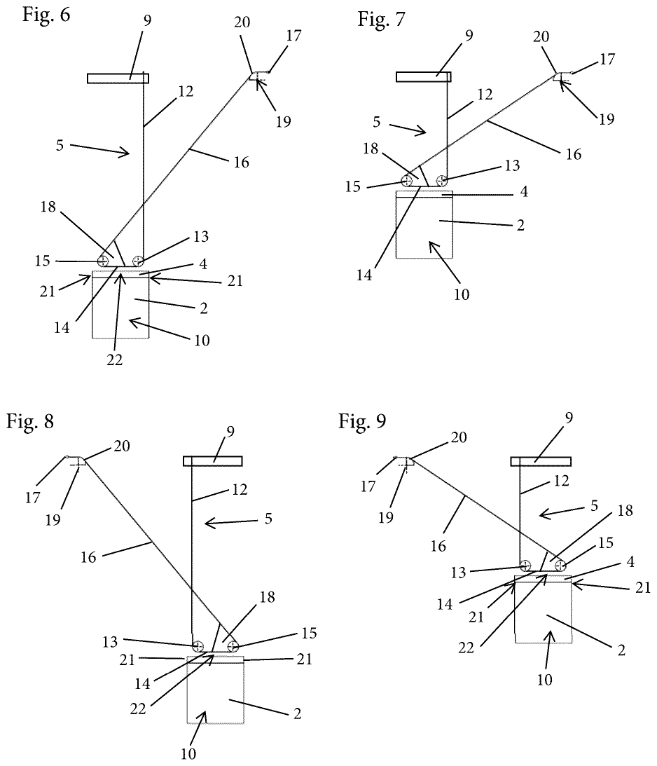

FIGS. 4 and 5, in turn, show views of the end side 10 of the transport arrangement 1 according to the invention of the exemplary embodiment shown here, wherein, in FIG. 4, the container 2 hanging on the load suspension device 4 is raised a bit further upwards and in FIG. 5, in comparison, is lowered a bit further downwards. The travel drives 8 shown on the trolley 3 in FIGS. 4 and 5 serve for moving the trolley 3 along the longitudinal member 33, as is known per se. In FIGS. 4 and 5, the cable drum axis 25 of the respective cable drum 9 is also shown in each case. The cable drums 9 are each mounted on the trolley 3 so as to be rotatable about their cable drum axis 25. In preferred embodiments, such as those shown here, the cable drum axes 25 of the cable drums 9 are arranged running parallel to each other and preferably also parallel to the end sides 10.

Whereas, in the previously explained figures, all eight lifting cables 5 and 6, i.e. all of the end-side lifting cables 5 and all of the longitudinal lifting cables 6, are illustrated, FIGS. 6 to 9 each show only one of the end-side lifting cables 5. All of the other lifting cables 5 and 6 are blanked out so that the course of the end-side lifting cable 5 actually illustrated can be clearly seen.

FIGS. 6 and 7 show one of the end-side lifting cables 5 in a further lowered position of the load suspension device 4 with the container 2, see FIG. 6, and in a further raised position of the load suspension device 4 and the container 2, see FIG. 7.

FIGS. 8 and 9 show the same illustrations, but for the other end-side lifting cable 5 present on this end side 10. In all of these illustrations according to FIGS. 6 to 9, it is seen that the respective end-side lifting cable 5 in each case runs substantially vertically on its first end-cable section 12, in order to then be deflected around the respective first end-side deflection pulley 13 into the second end-cable section 14, which runs substantially horizontally. Located at the end of the second end-cable section 14 is in each case the second end-side deflection pulley 15, by which the respective end-side lifting cable 5 is deflected into the third end-cable section 16. The latter extends between the second end-side deflection pulley 15 and the fixed end-side fastening point 17. It is also readily seen in FIGS. 6 to 9 that the third end-cable section 16 runs at an acute angle 18 relative to the second end-cable section 14 of the respective end-side lifting cable 5. The acute angle 18 changes depending on how far the load suspension device 4 is raised with or without the container 2 fastened thereto.

When the respective end-side lifting cable 5 is wound up onto or unwound from the cable drum 9, slight deviations in the course of the end-cable section 12 in relation to the vertical may occur. Corresponding deviations from the horizontal are also possible in principle for the second end-cable section 14, e.g. by the fact that the various end-cable sections 12, 14 and 16 have to be guided past one another without touching one another. For this reason, the discussion here involves the first end-cable section 12 running substantially vertically and the second end-cable section 14 running substantially horizontally. This is always achieved in the case of the first end-cable section 12 if the course thereof deviates from the vertical by an angle of a maximum of 4°. In the case of the second end-cable section 14, a substantially horizontal course is provided when the second end-cable section 14 deviates from the horizontal at an angle of a maximum of 4°.

In FIGS. 6 to 9, it is also readily seen that, in preferred exemplary embodiments, such as the one illustrated here, in the case of the respective end-side lifting cable 5, as seen in a corresponding side view of the respective end side 10, the third end-cable section 16 in each case crosses the first end-cable section 12 of the respective end-side lifting cable 5. Preferably, as also realized here, it is provided that, in the case of the end-side lifting cables 5, as seen in a side view of the respective end side 10, the second end-side deflection pulley 15 of the respective end-side lifting cable 5 and the fixed end-side fastening point 17 of the respective end-side lifting cable 5 are arranged on mutually opposite sides of the first end-cable section 12 of the respective end-side lifting cable 5.

As already explained at the beginning, the measure according to the invention and its preferred embodiments, as illustrated here once again, has the effect that it is possible to dispense with measures for active length compensation of the lifting cables 5 and 6 in order to compensate for a change in cable length when winding up and unwinding the lifting cables 5 and 6. This is expressed here by the ends of the lifting cables 5 and 6 opposite the respective cable drums 9 each being fastened to the trolley 3 at fixed end-side fastening points 17 or fixed longitudinal fastening points 29. The length compensation required in exemplary embodiments according to the invention is so slight that the elastic elongation of the lifting cables 5 and 6 is sufficient for this purpose.

Another measure which may be taken to further improve this is also illustrated in FIGS. 6 to 9. It is seen that the respective fixed end-side fastening points 17 of the end-side lifting cables 5 are each preceded by a deflection link 19 with a curved deflection surface 20. The respective end-side lifting cable 5 is guided in each case by its third end-cable section 16 over the curved deflection surface 20. Also in the case of the longitudinal lifting cables 6, the respective fixed longitudinal fastening point 29 can in principle be preceded in the same way by the deflection links 19, which are illustrated by way of example in FIGS. 6 to 9. However, exemplary embodiments of the invention are also possible, in which corresponding deflection links 19 are completely dispensed with both in the case of the end-side lifting cables 5 and in the case of the longitudinal lifting cables 6.

In particular, it is also seen in FIGS. 6 to 9 that, advantageously, the first end-side deflection pulley 13 and the second end-side deflection pulley 15 of the respective end-side lifting cable 5 are arranged as far as possible on the respective edge 21 of the load suspension device 4. In this context, as also shown here, it is therefore advantageously provided that, as seen in a side view of the respective end side 10, the first end-side deflection pulley 13 and the second end-side deflection pulley 15 of each end-side lifting cable 5 are each arranged on the load suspension device 4 closer to an edge 21 of the load suspension device 4 than to a centre 22 of the load suspension device 4. They are advantageously arranged on mutually opposite edges 21 of the load suspension device 4.

It can also be readily gathered from the overall view of FIGS. 4 to 9 that, in preferred embodiments, as realized here, the two end-side lifting cables 5 arranged on the respective end side 10, as seen in a side view of the respective end side 10, are arranged mirror-symmetrically to each other.

In a direction normal to the respective end side 10, the first end-cable section 12 and the second end-cable section 14 and the third end-cable section 16 of the respective end-side lifting cable 5 advantageously run as close to one another as possible. In practice, a certain offset is usually necessary so that the various end-cable sections 12, 14 and 16, in particular the first end-cable section 12 and the third end-cable section 16, can be guided past each other without contact. In order to ensure all of this, it is advantageously provided, as shown in FIG. 11 in a top view of the load suspension device 4, that the first end-cable section 12 and the second end-cable section 14 and the third end-cable section 16 of the respective end-side lifting cable 5 run completely between two imaginary, vertical planes 23 which are parallel to each other, the planes 23 being at a distance 24 from each other of 150 mm to 250 mm, preferably of 180 mm to 220 mm. FIG. 11 shows a top view of the section plane A-A shown in FIG. 10.

FIGS. 10 and 12 each show a side view of the longitudinal side 11 of the transport arrangement 1, which is shown here by way of example. In FIG. 10, the load suspension device 4 with the container 2 fastened thereto is raised a bit further than in FIG. 12. FIGS. 10 and 12 particularly readily show the course, preferably realized here, of the longitudinal lifting cables 6. Preferably, as also shown here, two of the lifting cables 6 are arranged as longitudinal lifting cables 6 on each of the longitudinal sides 11. Each of said longitudinal lifting cables 6 is preferably guided, as also shown here, to the trolley 3 from the respective cable drum 9 on a first longitudinal-cable section 26 to a longitudinal deflection pulley 27, which is fastened to the load suspension device 4, and on a second longitudinal-cable section 28 to the fixed longitudinal fastening point 29, which can be better seen in FIG. 3. As seen in the side view of the respective longitudinal side 11 according to FIGS. 10 and 12, the longitudinal deflection pulleys 27 are each located in the centre 30 of the load suspension device 4. The first longitudinal-cable section 26 and the second longitudinal-cable section 28 of the respective lifting cable 6 advantageously in turn run substantially parallel, as illustrated here. Here too, the wording “substantially” means that deviations of a maximum of 4°from an exactly parallel course should not be exceeded. It is also readily seen in FIGS. 10 and 12 that the longitudinal lifting cables 6 arranged on the respective longitudinal side 11 are preferably arranged mirror-symmetrically to each other, when viewed in the corresponding side view of the respective longitudinal side 11.

The courses explained here by way of example in this exemplary embodiment are advantageously realized for all of the end-side lifting cables 5 or for all of the longitudinal lifting cables 6.

### KEY TO THE REFERENCE SIGNS

| | |
|---|---|
| 1 | Transport arrangement |
| 2 | Container |
| 3 | Trolley |
| 4 | Load suspension device |
| 5 | Lifting cable |
| 6 | Lifting cable |
| 7 | Fastening unit |
| 8 | Travel drive |
| 9 | Cable drum |
| 10 | End side |
| 11 | Longitudinal side |
| 12 | First end-cable section |
| 13 | First end-side deflection pulley |
| 14 | Second end-cable section |
| 15 | Second end-side deflection pulley |
| 16 | Third end-cable section |
| 17 | Fixed end-side fastening point |
| 18 | Acute angle |
| 19 | Deflection link |
| 20 | Deflection surface |
| 21 | Edge |
| 22 | Centre |
| 23 | Plane |
| 24 | Distance |
| 25 | Cable drum axis |
| 26 | First longitudinal-cable section |
| 27 | Longitudinal deflection pulley |
| 28 | Second longitudinal-cable section |
| 29 | Fixed longitudinal fasteningpoint |
| 30 | Centre |
| 31 | Gantry crane |
| 32 | Overhead crane |
| 33 | Longitudinal member |
| 34 | Support |
| 35 | Running gear |

1. A transport arrangement for transporting a container or another load, the transport arrangement comprising:
a trolley;
a load suspension device and eight lifting cables, the load suspension device has at least one fastening unit that is configured for fastening the container or the other load to the load suspension device;
the load suspension device hangs height-adjustably on the trolley by the eight lifting cables;
two or more cable drums on the trolley, and at least one of the eight lifting cables is mounted on each of the cable drums so as to be windable and unwindable;
the transport arrangement includes two mutually opposite end sides and two mutually opposite longitudinal sides, the longitudinal sides being longer than the end sides;
in each case two of the eight lifting cables are arranged as end-side lifting cables on each of the end sides, each of said end-side lifting cables being guided from the respective cable drum on a first end-cable section to a first end-side deflection pulley, which is fastened to the load suspension device, and on a second end-cable section to a second end-side deflection pulley, which is fastened to the load suspension device, and on a third end-cable section to a fixed end-side fastening point on the trolley.

2. The transport arrangement according to claim 1, wherein the end-side lifting cables each run substantially vertically at the respective first end-cable section by enclosing an angle of a maximum of 4° with respect to vertical.

3. The transport arrangement according to claim 2, wherein the end-side lifting cables each run substantially horizontally at the respective second end-cable section thereof by enclosing an angle of a maximum of 4° with respect to horizontal, and for the end-side lifting cables, as seen in a side view of the respective end side, the third end-cable section of the respective end-side lifting cable runs at an acute angle relative to the second end-cable section of the respective end-side lifting cable.

4. The transport arrangement according to claim 1, wherein the end-side lifting cables each run substantially horizontally at the respective second end-cable section thereof by enclosing an angle of a maximum of 4° with respect to horizontal.

5. The transport arrangement according to claim 1, wherein, for the end-side lifting cables, as seen in a side view of the respective end side, the third end-cable section of the respective end-side lifting cable runs at an acute angle relative to the second end-cable section of the respective end-side lifting cable.

6. The transport arrangement according to claim 1, wherein, for the end-side lifting cables, as seen in a side view of the respective end side, in each case the third end-cable section of the respective end-side lifting cable crosses the first end-cable section of the respective end-side lifting cable.

7. The transport arrangement according to claim 1, wherein, for the end-side lifting cables, as seen in a side view of the respective end side, the second end-side deflection pulley of the respective end-side lifting cable and the fixed end-side fastening point of the respective end-side lifting cable are arranged on mutually opposite sides of the first end-cable section of the respective end-side lifting cable.

8. The transport arrangement according to claim 1, wherein the fixed end-side fastening points of the respective end-side lifting cables are each preceded by a deflection link with a curved deflection surface, and the respective end-side lifting cable is guided in each case with the third end-cable section thereof over the curved deflection surface.

9. The transport arrangement according to claim 1, wherein, as seen in a side view of the respective end side, the first end-side deflection pulley and the second end-side deflection pulley of each said end-side lifting cable are each arranged on the load suspension device closer to an edge of the load suspension device than to a centre of the load suspension device.

10. The transport arrangement according to claim 1, wherein, as seen in a side view of the respective end side, the two end-side lifting cables arranged on the respective end sides are arranged mirror-symmetrically to each other.

11. The transport arrangement according to claim 1, wherein, as seen in a top view of the load suspension device, the first end-cable section and the second end-cable section and the third end-cable section of each respective end-side lifting cable run completely between two imaginary, vertical planes which are parallel to each other, the planes being at a distance from each other of 150 mm to 250 mm.

12. The transport arrangement according to claim 1, wherein the cable drums are each rotatably mounted about a cable drum axis and the cable drum axes of the cable drums are arranged parallel to each other and/or running parallel to the end sides.

13. The transport arrangement according to claim 1, wherein two of the lifting cables are arranged as longitudinal lifting cables on each of the longitudinal sides, each of said longitudinal lifting cables being guided from the respective cable drum on a first longitudinal-cable section to a longitudinal deflection pulley, fastened to the load suspension device, and on a second longitudinal-cable section to a fixed longitudinal fastening point on the trolley.

14. The transport arrangement according to claim 13, wherein the longitudinal deflection pulleys, as seen in a side view of the respective longitudinal side, are each fastened to the load suspension device in a centre of the load suspension device.

15. The transport arrangement according to claim 13, wherein, as seen in a side view of the respective longitudinal side, the two longitudinal lifting cables, arranged on the respective longitudinal sides, are arranged mirror-symmetrically to each other.

16. A crane comprising at least one longitudinal member on which the transport arrangement according to claims 1 is mounted movably by a trolley along the longitudinal member.
